(19) United States
(12) Patent Application Publication
(10) Pub. No.: US 2006/0000627 A1
(43) Pub. Date: Jan. 5, 2006

(54) Device with inner and outer shells of a housing of a hand machine tool, and hand machine tool provided therewith

(76) Inventors: Karl Frauhammer, Leinfelden-Echterdingen (DE); Heinz Schnerring, Dettenhausen (DE); Willy Braun, Neustetten (DE); Axel Kuhnle, Freiberg A.N. (DE)

Correspondence Address: STRIKER, STRIKER & STENBY, 103 EAST NECK ROAD, HUNTINGTON, NY, 17743, US

(21) Appl. No.: 11/167,725

(22) Filed: Jun. 27, 2005

(30) Foreign Application Priority Data
Jun. 30, 2004 (DE) 102004031628.7

(51) Int. Cl. B25D 11/00

(52) U.S. Cl. 173/201; 173/217

(57) ABSTRACT

A device for a hand machine tool equipped with a hammer mechanism has a housing having an inner shell and an outer shell, which the inner shell and the outer shell are of one piece with each other at least in a subregion to be associated with the hammer mechanism; and also a hand machine tool is provided with such a device.

### BACKGROUND OF THE INVENTION

The present invention relates to a device with inner and outer shells of a housing of a hand machine tool, and to a hand machine tool provided therewith.

The prior art already includes designs in which a hand machine tool with a hammer mechanism is equipped with an inner shell and an outer shell. This can prevent heat that is generated in the region of the hammer mechanism from being transmitted directly to the outer shell and generating temperatures there that make it painful and/or dangerous to grasp the outer shell in the corresponding region.

### SUMMARY OF THE INVENTION

Accordingly, it is an object of the present invention to provide a device with inner and outer shells of a housing of a hand machine tool as well as a hand machine tool provided therewith, which eliminates the disadvantages of the prior art.

The present invention is based on a device with an inner shell and an outer shell of a housing of a hand machine tool with a hammer mechanism.

According to the present invention, the inner shell and outer shell are embodied as being of one piece with each other, at least in a subregion associated with the hammer mechanism. This makes it easily possible to advantageously exploit potential savings.

In one embodiment of the present invention, the inner shell and the outer shell are connected to each other by means of at least one bridge piece. This makes it possible to achieve a comparatively low heat flow between the inner shell and the outer shell while simultaneously achieving a sufficiently high stability, particularly if the bridge piece is embodied as thinner than the outer shell and the inner shell and/or if a thickness of the bridge piece is less than 2 mm. A particularly high stability with a simultaneously thin bridge piece can be achieved if the bridge piece extends in a curve or in a wave form.

Because of the high stability requirements, the embodiment according to the present invention can be used to particular advantage in connection with percussion drills and hammer drills. Since a large amount of heat is generated in such hammer mechanisms, the advantages of the present invention that relate to improved heat transport and/or improved heat conduction can be used particularly in connection with hammer drills; the potential savings are of particular significance in small and/or medium-sized hammer drills with a weight of between 2.5 and 4.5 kg.

An advantageous, effective heat removal and high heat resistance of the housing can be achieved if the housing has at least one metallic subregion.

Additional design advantages can also be achieved particularly if the outer shell has a metallic subregion.

A particularly lightweight yet rugged design can be achieved if the metallic subregion is comprised of a light metal or a light metal alloy. Possible materials include aluminum or magnesium, for example.

In a particularly inexpensive embodiment of the invention, the metallic subregion is comprised of an injection molded component. A lightweight, high stability hand power tool can be achieved if the metallic subregion is comprised of aluminum and/or magnesium. There are also conceivable embodiments of the present invention in which the metallic subregion is embodied in the form of a deep-drawn sheet-metal part.

An overheating of the outer shell and an accompanying loss of operating comfort can be advantageously avoided if an intermediate space between the inner shell and the outer shell is provided to accommodate a cooling airflow. The term “provided” is understood in this context to also mean “designed” and “equipped”.

If a motor ventilation unit of the hand power tool generates the cooling airflow, then the elimination of a separate ventilation unit makes it possible to exploit further potential savings. The motor ventilation unit here can either suck or blow the cooling airflow into the intermediate space. The cooling airflow can be comprised of the total cooling airflow generated by the motor ventilation unit or of a partial flow that is separated from the total cooling airflow generated by the motor ventilation unit. There are also conceivable embodiments of the present invention in which several partial flows are separated off from the main cooling airflow, at least some of which are conveyed into various regions of the intermediate space.

In this case, dust and/or abraded material can be reliably prevented from penetrating into a hammer mechanism region of the housing if at least the inner shell constitutes part of a dividing and/or sealing surface between a motor region and the hammer mechanism region of the housing, particularly if the dividing and/or sealing surface completely protects the hammer mechanism region from the motor region.

A particularly favorable heat insulation or a particularly effective removal of the heat generated in the region of the hammer mechanism can be achieved if the intermediate space between the inner shell and the outer shell encloses the hammer mechanism in an at least essentially complete fashion.

An introduction of cooling air into the subregion of the housing associated with the hammer mechanism can be achieved in a particularly simple structural way in a one-piece embodiment of the inner shell and outer shell if the inner shell and the outer shell constitute boundaries of at least one air pocket. A particularly effective cooling can be achieved if the housing has several, for example three or four, air pockets distributed around the circumference of the hammer mechanism. In this case, the air pockets can be advantageously integrated into the dividing and/or sealing surface in a material-saving fashion.

If the outer shell in the region associated with the hammer mechanism has at least one air opening, then heat can be transported outward from the inner shell in a particularly advantageous manner in this region by means of an airflow through the ventilation slots, without extended operation causing the outer shell to exceed a temperature that would make it unpleasant and/or dangerous to grasp the outer shell. It is possible to achieve an embodiment in which the temperature of the outer shell does not exceed 80° C., even with intensive extended operation of the hand machine tool. In particularly advantageous embodiments of the present invention, the outer shell has a number of ventilation openings and/or ventilation slots that can be arranged, for example, in a grid pattern.

Other advantages ensue from the following description of the drawings. The drawings depict an exemplary embodiment of the invention. The drawings, the specification, and the claims contain numerous features in combination. A person skilled in the art will also suitably consider the features individually and unite them in other meaningful combinations.

### BRIEF DESCRIPTION OF THE DRAWINGS

FIG. 1 shows a side view of a hammer drill with a hammer mechanism,

FIG. 2 shows a sectional view of the hammer drill from FIG. 1, with an inner shell and an outer shell of a housing as well as a hammer mechanism, and

FIG. 3 shows the housing part from FIG. 2, viewed from a working direction.

### DESCRIPTION OF THE PREFERRED EMBODIMENTS

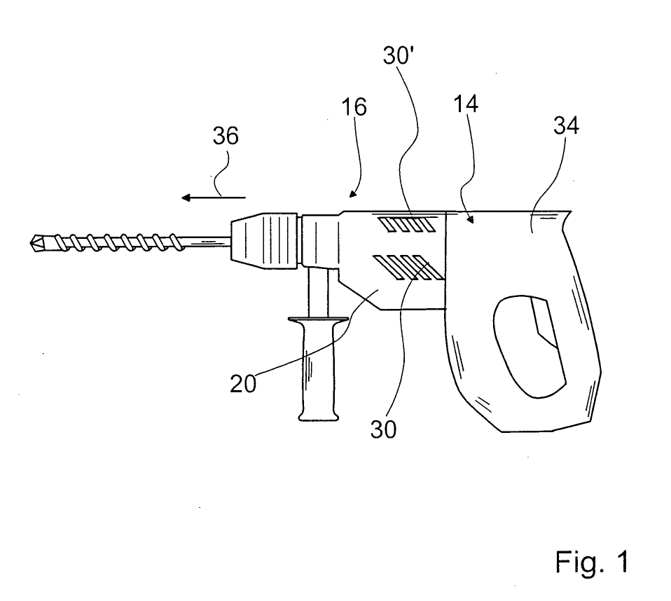

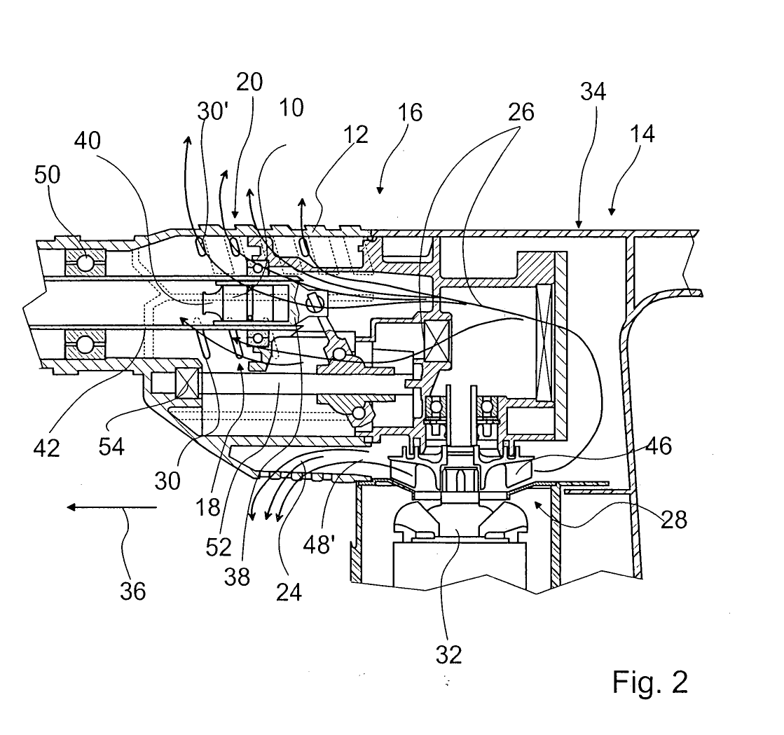

FIG. 1 shows a hand machine tool 16 embodied in the form of a hammer drill that has a housing 14, which, in a front subregion 20 associated with a hammer mechanism 18 (FIG. 2) of the hand machine tool 16, is comprised of light metal or aluminum embodied in the form of a cast aluminum part, and, in a rear subregion 34 associated with an electric motor 32 of the hand machine tool 16, is embodied in the form of a cast plastic part. There are also conceivable embodiments of the present invention in which the metallic subregion is comprised of magnesium or of a light metal alloy. The rear subregion 34 includes a D-shaped handle element into which the electric motor 32 is integrated. The front subregion 20 and the rear subregion 34 constitute respective one-piece cast housing parts.

Each side of the front, metallic subregion 20 has two grid-shaped ventilation openings 30-30′″, each comprised of four slots. The slots are inclined diagonally upward at an approximately 45° angle in relation to a working direction 36.

FIG. 2 shows a sectional view of a detail of the hand machine tool 16 including the hammer mechanism 18 and the front subregion 20. The hammer mechanism 18 has a cup piston 38 in which a hammer 40 is supported in an axially mobile fashion. The cup piston 38 is in turn supported in an axially mobile fashion in a hammer tube 42 and is driven by the electric motor 32 in a hammer drilling operating mode and in a chisel mode. The hammer 42 transmits axially oriented impetuses to a die not explicitly depicted here, which transmits the impetus to a tool.

The hammer tube 42 is comprised of steel and is snugly screwed to the housing 14. The movement of the hammer 40 and the die and the impact of the hammer 40 against the die generate heat in the hammer mechanism 18, which is transmitted to the housing 14 via the hammer tube 42.

In the front subregion 20, the housing 14 is comprised of two shells, an inner shell 10 and an outer shell 12 that is of one piece with the inner shell 10; the inner and outer shells delimit a number of air pockets 44-44′″, which are separated from one another by bridge pieces 22-22″ and whose interiors constitute an intermediate space 24 between the inner shell 10 and the outer shell 12 through which a cooling airflow 26 flows. A motor ventilation unit 28 equipped with a fan impeller 46 mounted on a motor shaft of the electric motor 32 generates the cooling airflow 26.

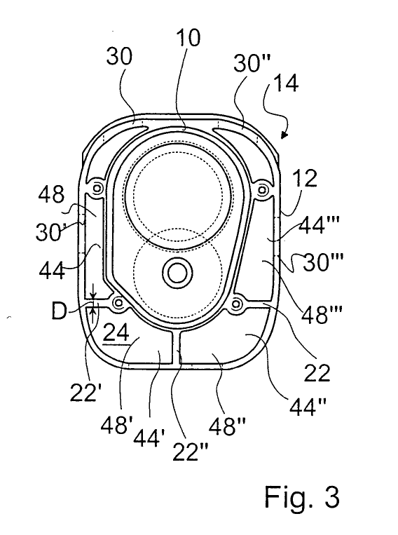

To this end, the side of the front subregion 20 oriented away from the working direction 36, which is provided to be screw connected to the rear subregion 34, has a number of openings 48-48′″ through which the cooling airflow 26 can flow into the air pockets 44-44′″ (FIG. 3). The cooling airflow 26 flows through the air pockets 44-44′″ in the working direction 36 and exits the air pockets 44-44′″ through the slot-shaped ventilation openings 30-30′″ in a region of the air pockets 44-44′″ situated radially toward the outside in relation to the working direction 36. In the process, the cooling airflow 26 sweeps across the inner shell 10 of the front subregion 20 of the housing 14, which is in thermal contact with the hammer mechanism 18. During operation, the cooling airflow 26 cools the hammer tube 42 via the inner shell 10 of the housing 14 and is itself heated. The heated cooling airflow 26 then transports the heat absorbed from the hammer tube 42 through the ventilation openings 30-30′″ to the outside of the hand machine tool 16.

The bridge pieces 22-22″ that connect the inner shell 10 to the outer shell 12 have a thickness D that is less than that of the inner shell 10 and outer shell 12, which are approximately 2.5 mm thick, whereas the bridge pieces 22-22″ are only approximately 2 mm thick. As a result, metallic thermal conduction transmits a sufficiently low amount of heat from the inner shell 10 to the outer shell 12 via the bridge pieces 22-22″ to assure that even with extended operation of the hand machine tool 16 in a hammer drilling mode, the temperature of the outer shell 12 will not exceed 70° C.-80° C.

FIG. 3 shows the segmented design of the front, metallic subregion 20 of the hand machine tool 16. The cooling airflow 26 passes through the openings 48-48′″ into the intermediate space 24 between the inner shell 10 and the outer shell 12, which is subdivided into pocket-shaped segments and/or into the air pockets 44-44′″ that are separated from one another by the bridge pieces 22-22″. The cooling airflow 26 is thus divided into four partial flows that are each associated with one of the segments.

In a region situated in the working direction 36, the subregion 20 has a tube end that is provided to accommodate a bearing 50 for supporting the hammer tube 42 in a rotatable, axially fixed manner.

In a front, lower region, the subregion 20 has a recess provided to accommodate an intermediate shaft 52 and an additional bearing 54 for supporting the intermediate shaft 52 in a rotatable manner. Both bearings 50, 54 are thus in direct thermal contact with the metallic subregion 20 of the hand machine tool 16.

It will be understood that each of the elements described above, or two or more together, may also find a useful application in other types of constructions differing from the types described above.

While the invention has been illustrated and described as embodied in a device with inner and an outer shells of a housing of a hand machine tool, and a hand machine tool provided therewith, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

What is claimed is:

1. A device for a hand machine tool equipped with a hammer mechanism, comprising a housing having an inner shell and an outer shell, said inner shell and said outer shell being of one piece with each other at least in a subregion to be associated with the hammer mechanism.

2. A device as defined in claim 1; and further comprising at least one bridge piece which connects said inner shell and said outer shell to each other.

3. A device as defined in claim 2, wherein said bridge piece is thinner than said outer shell and said inner shell.

4. A device as defined in claim 2, wherein said bridge piece has a thickness which is less than 2 mm.

5. A device as defined in claim 1, wherein said housing has at least one metallic subregion.

6. A device as defined in claim 5, wherein said metallic subregion of said housing is composed of a light metal.

7. A device as defined in claim 1, wherein said inner shell and said outer shell provide therebetween an intermediate space for accommodating a cooling airflow.

8. A device as defined in claim 7, wherein said intermediate space between said inner shell and said outer shell is formed so as to accommodate the cooling airflow generated by a motor ventilation unit of the hand machine tool.

9. A device as defined in claim 1, wherein at least said inner shell forms a part of a surface between a motor region and a hammer mechanism region of said housing, the surface being selected from the group consisting of a dividing surface, a sealing surface, and both.

10. A device as defined in claim 1, wherein said inner shell and said outer shell provide therebetween an intermediate space formed so as to enclose the hammer mechanism in at least substantially complete fashion.

11. A device as defined in claim 1, wherein said inner shell and said outer shell are formed so as to constitute boundaries of at least one air pocket.

12. A device as defined in claim 1, wherein said outer shell has at least one ventilation opening in the subregion to be associated with the hammer mechanism.

13. A hand machine tool, comprising a hammer mechanism; and a housing including an inner shell and an outer shell, said inner shell and said outer shell being of one piece with each other, at least in a subregion associated with said hammer mechanism.

14. A hand machine tool as defined in claim 13; and further comprising at least one bridge piece which connects said inner shell and said outer shell to each other.

15. A hand machine tool as defined in claim 14, wherein said bridge piece is thinner than said outer shell and said inner shell.

16. A hand machine tool as defined in claim 14, wherein said bridge piece has a thickness which is less than 2 mm.

17. A hand machine tool as defined in claim 13, wherein said housing has at least one metallic subregion.

18. A hand machine tool as defined in claim 17, wherein said metallic subregion of said housing is composed of a light metal.

19. A hand machine tool as defined in claim 13, wherein said inner shell and said outer shell provide therebetween an intermediate space for accommodating a cooling airflow.

20. A hand machine tool as defined in claim 19, further comprising a motor ventilation unit, wherein said intermediate space between said inner shell and said outer shell is formed for accommodating the cooling airflow generated by said motor ventilation unit.

21. A hand machine tool as defined in claim 13, wherein at least said inner shell forms a part of a surface between a motor region and a hammer mechanism region of said housing, the surface being selected from the group consisting of a dividing surface, a sealing surface, and both.

22. A hand machine tool as defined in claim 13, wherein said inner shell and said outer shell provide therebetween an intermediate space formed so as to enclose said hammer mechanism in at least substantially complete fashion.

23. A hand machine tool as defined in claim 13, wherein said inner shell and said outer shell are formed so as to constitute boundaries of at least one air pocket.

24. A hand machine tool as defined in claim 13, wherein said outer shell has at least one ventilation opening in the subregion to be associated with said hammer mechanism.
